(19) United States
(12) Patent Application Publication
(10) Pub. No.: US 2008/0131853 A1
(43) Pub. Date: Jun. 5, 2008

(54) Vidio interface for learning an activity

(76) Inventor: James Kunitz, La Mesa, CA (US)

Correspondence Address: PATTON BOGGS LLP, 1801 CALFORNIA STREET, SUITE 4900, DENVER, CO, 80202, US

(21) Appl. No.: 11/821,991

(22) Filed: Jun. 26, 2007

Related U.S. Application Data
(60) Provisional application No. 60/868,058, filed on Nov. 30, 2006.

(51) Int. Cl. G09B 19/00

(52) U.S. Cl. 434/250

(57) ABSTRACT

A video interface may include a video region configured to display a primary video demonstrating an activity. The primary video may be defined by portions of primary video demonstrating respective sub-activities of the activity. Video segments may be associated with respective portions of the primary video, where the video segments include additional information of respective sub-activities displayed in the respective portions of the primary video. A selectable indicia may be displayed in association with the video region. The selectable indicia may use a link address to cause a video segment associated with a respective portion of the primary video being displayed at a time the selectable indicia is selected by a user to be displayed.

### RELATED APPLICATIONS

This application claims priority to U.S. Provisional Patent Application Ser. No. 60/868,058 filed on Nov. 30, 2006, the entire teachings of which are incorporated herein by reference.

### BACKGROUND

Instructional videos have traditionally provided instruction and demonstration of particular activities. Instructional videos were originally produced in a linear format on video tape and a viewer would have to watch a video from beginning to end to learn the content contained in the video. With the development of CDs, DVDs, and the Internet, instructional videos have taken advantage of the flexibility provided by these digital, random access formats. For example, digital formats provide for a menu system that enables an author to define scenes, chapters or other segments for a viewer to selectively watch one video segment without having to scan through other video segments.

Demonstration portions of instructional videos are generally used to show a complete activity. For example, in the case of a ballroom or other style dance video, demonstration of a dance shows dancers performing a complete dance routine. A viewer who is learning to dance may find it difficult to determine exactly how a particular dance step is performed. The viewer has the option of (i) rewinding and replaying the particular dance step and attempt to figure out how the step was performed or (ii) returning to a menu and determine if that particular dance step is taught elsewhere on the video. One problem that exists when using either of these techniques to learn a dance step is that the viewer has to figure out how to perform a dance step when integrated into a full dance routine or figure out or guess what the dance step is to select instruction for the particular dance step from a menu. It should be understood that the problem of trying to learn a particular sub-activity (e.g., particular dance step) from a demonstration of an activity (e.g., dance type) on a video exists with many other activities, including medical surgical procedures, karate, yoga, and other activities.

### SUMMARY

To overcome the problem of trying to learn a particular sub-activity from a demonstration of an activity on a video, video segments that include additional or detailed information of respective sub-activities may be selectively accessed and displayed in response to a user selecting a selectable indicia (e.g., soft-button) when an associated sub-activity is being displayed in the video. The detailed information may include a lesson that teaches the sub-activity (e.g., half-moon step in a cha-cha dance). By dynamically associating video segments with portions of the video, the viewer does not have to know the name of each sub-activity to access detailed information of how the sub-activity IS performed.

One embodiment of the present invention includes a video interface for teaching a user how to perform an activity. The video interface may include a video region configured to display a primary video demonstrating an activity. The primary video may be defined by portions of primary video demonstrating respective sub-activities of the activity. Video segments may be associated with respective portions of the primary video, where the video segments include additional information of respective sub-activities displayed in the respective portions of the primary video. A selectable indicia may be displayed in association with the video region. The selectable indicia may use a link address to cause a video segment associated with a respective portion of the primary video being displayed at a time the selectable indicia is selected by a user to be displayed.

One method for enabling a user to view a video in accordance with the principles of the present invention may include storing a primary video demonstrating an activity. The primary video may be defined into portions demonstrating respective sub-activities of the activity. Video segments associated with portions of the primary video may be stored, where the video segments include additional information of respective sub-activities displayed in the respective portions of the primary video. A set of addresses associated with starting locations of respective video segments may be established. In response to a user selecting a selectable indicia, an address within the set of addresses may be used to cause an associated video segment to be displayed, where the video segment is associated with a respective portion of the primary video being displayed at a time the user selects the selectable indicia.

One embodiment for storage of an authored video in accordance with the principles of the present invention may include a computer-readable medium on which computer instructions are stored. The computer instructions, when executed by a processor, may cause the processor to (i) display a primary video demonstrating an activity, where the primary video may be defined by portions of video demonstrating respective sub-activities, and (i) display a selectable indicia that, when selected by a user, causes a video segment to be displayed, where the video segment includes additional information of a respective sub-activity being in a respective portion of the primary video being displayed at a time the selectable indicia is selected by the user.

### BRIEF DESCRIPTION OF THE DRAWINGS

Illustrative embodiments of the present invention are described in detail below with reference to the attached drawing figures, which are incorporated by reference herein and wherein:

FIG. 1 is a screenshot of an exemplary user interface showing a video and selectable indicia;

FIG. 2 is a screenshot of an exemplary user interface showing a different view in response to a selection of a selectable indicia by a user;

FIG. 3 is a screenshot of a video that includes additional information associated with a portion of the video of FIG. 1;

FIGS. 4A-4C are illustrations of exemplary machine-readable media that include video content that provides a user with the ability to view detailed information associated with a portion of a video in accordance with the principles of the present invention;

FIG. 5 is a block diagram of an exemplary configuration of a video and video segments associated with portions of the video; and

FIG. 6 is a flow diagram of an exemplary process for enabling a viewer to view a video.

### DETAILED DESCRIPTION OF THE DRAWINGS

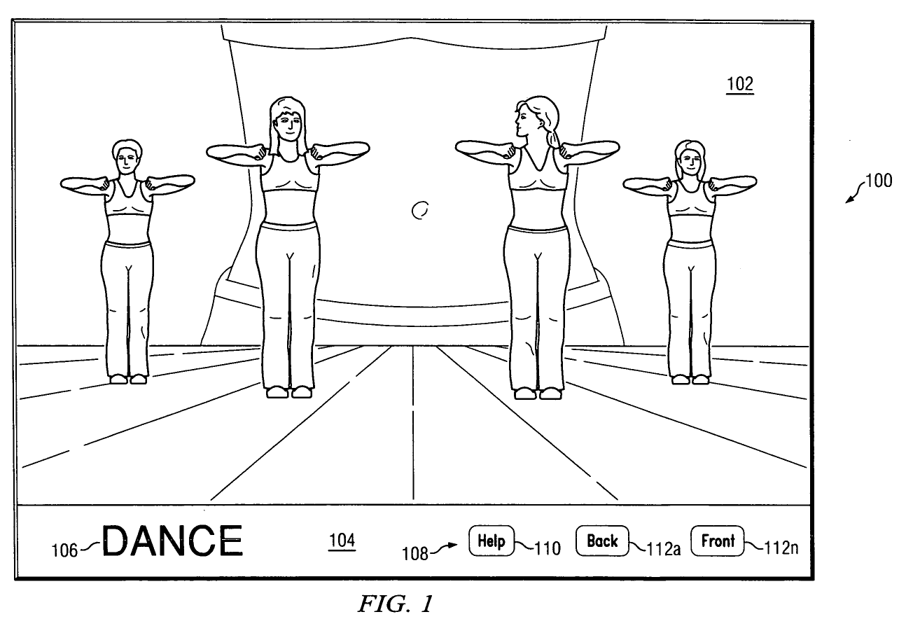

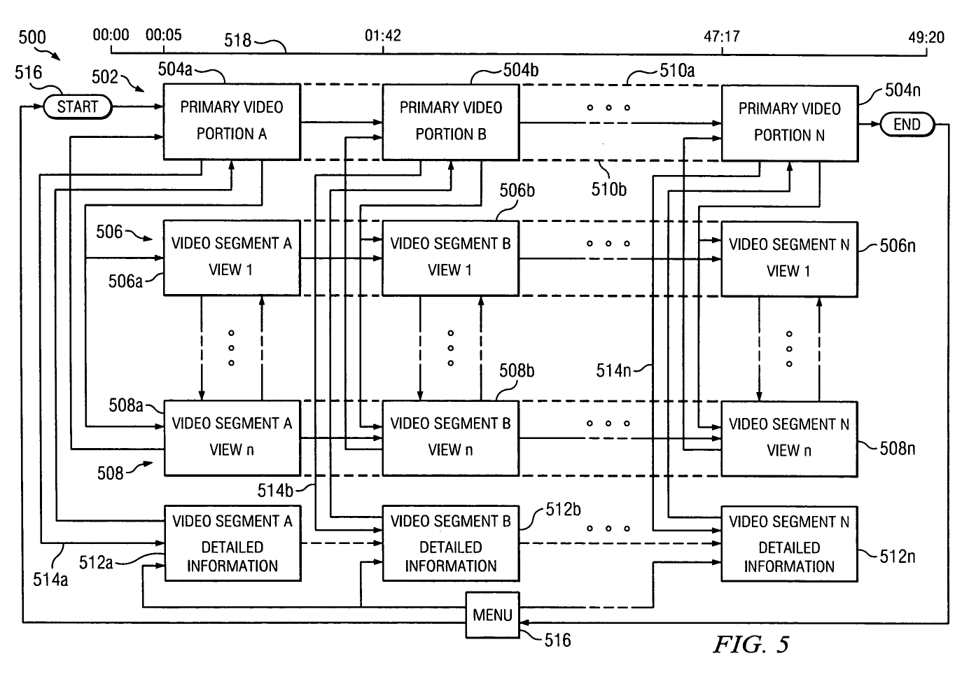

FIG. 1 is a screenshot 100 of an exemplary user interface showing video and selectable indicia 108. The screenshot 100 shows a video region 102 and a graphics region 104. The video region 102 may display a video of an activity, such as dancing, and the graphics region 104 may display a title 106 and selectable indicia 108. The selectable indicia 108 may include soft-buttons, graphics, or other indicia that notifies a viewer of available viewing options. The selectable indicia 108 may include one or more soft-buttons, for example, and be associated with the video region 102. In associating the selectable indicia 108 with the video region 102, the selectable indicia 108 may be located in a graphics region, on the video region 102, or anywhere else on the user interface. The selectable indicia 108 may include a “help” or other named soft-button 110 and view angle buttons 112a-112n (collectively, 112). The help soft-button 110 may have an associated link address (not shown) that is associated with a video segment that includes additional or detailed information associated with a sub-activity that is currently being displayed in the video region 102. The video that is displayed in the video region 102 may be defined as multiple video portions, where each video portion shows a sub-activity of the activity that is being displayed in the video (see FIG. 5). The link address may be associated with the help soft-button 110 and change for the soft-button 110 to use when the video crosses into different sub-activities. For example, if the video is showing a dance couple performing a box step and transitions into a conversation step, then the link address changes from an address associated with a video segment that includes content that teaches the box step to an address associated with a video segment that teaches the conversation step.

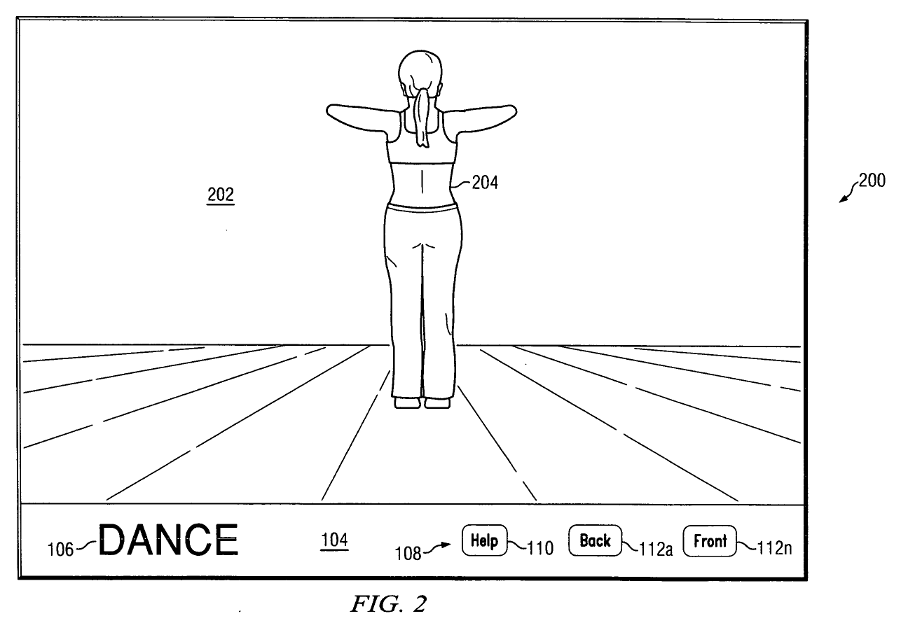

The view angle soft-buttons 112 may enable the viewer to switch between view angles of the video. For example, view angles of back and front are available for the video being shown in video region 102. The viewer may select the back view angle soft-button 112a to view the video being displayed from the rear (see FIG. 2) and select the front view angle soft-button 112n to view the video from the front (FIG. 1). The view angles may not necessarily be recorded at the same time, but may be synchronized such that a viewer sees the activity being performed at the different angles and have a sense that the sub-activity being displayed from any of the angles was simultaneously recorded. It should be understood that the view angles may include up to 8 or more different view angles, depending upon the subject matter that is being displayed in the video. For example, if a surgical procedure is being performed, surgeons may want to view the operating area from many different angles and providing a viewer with the ability to select to view the surgical procedure from many different angles enables the viewer to better understand the specifics and subtleties involved in the surgical procedure.

FIG. 2 is a screenshot 200 of an exemplary user interface showing a different view in response to a selection of selectable indicia by a user. As shown, the video shown in video region 202 shows a rear view of a dancer 204, thereby enabling the viewer to understand dance moves as seen from the rear of the dancer 204. By showing the rear view, the viewer may better understand specifically what the dancer 204 is doing from a different angle than that shown in the video of FIG. 1. The viewer may select any of the selectable indicia 108 to change the view angle or view a video segment including additional information of the sub-activity being displayed in the video at the time the viewer or user selects the soft-button 110.

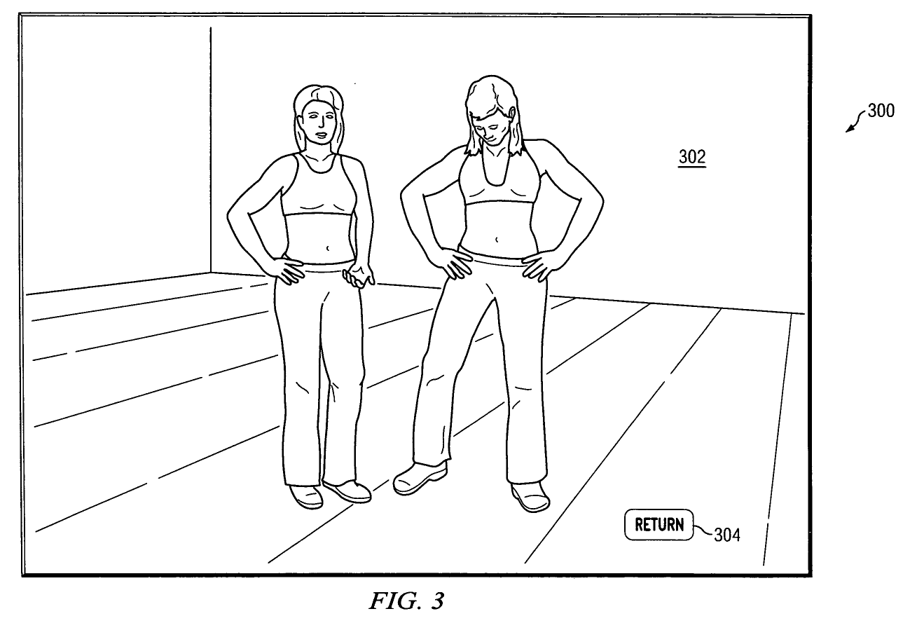

FIG. 3 is a screenshot 300 of a video segment being displayed in a video region 302, where the video segment includes additional information associated with a portion of the video of FIG. 1. The video segment shown in video region 302 may be of any length and include information that helps a viewer learn more about a sub-activity that was being shown in the video at the time the viewer selected the help soft-button 110 (FIGS. 1 and 2). For example, if the video is shown a particular sub-activity (e.g., half-moon step) of an activity (e.g., waltz dance), then the video segment may teach how to perform the half-moon step. It should be understood that the video segment may provide any information, including verbal, text, video, graphics, or otherwise, to provide the viewer with additional information associated with a sub-activity that is currently being demonstrated in the video at the time that the user selects the help soft-button 110. It should be understood that the term “help” is exemplary and that any other indicia, such as a graphic or text, could be used to indicate to the view that additional information associated with the sub-assignment is available for viewing. A selectable indicia 304 (e.g., “return”) that enables the viewer to return to the video being displayed in FIG. 1 or 2, depending upon which of those video interfaces the user was watching at the time he or she selected to view the video segment including additional information of the sub-activity being displayed. In one embodiment, returning to the video being displayed in either FIG. 1 or 2 may return to the start of a video portion from which the viewer selected the help soft-button 110 or, alternatively, from the point in time that the viewer selected the help soft-button 110.

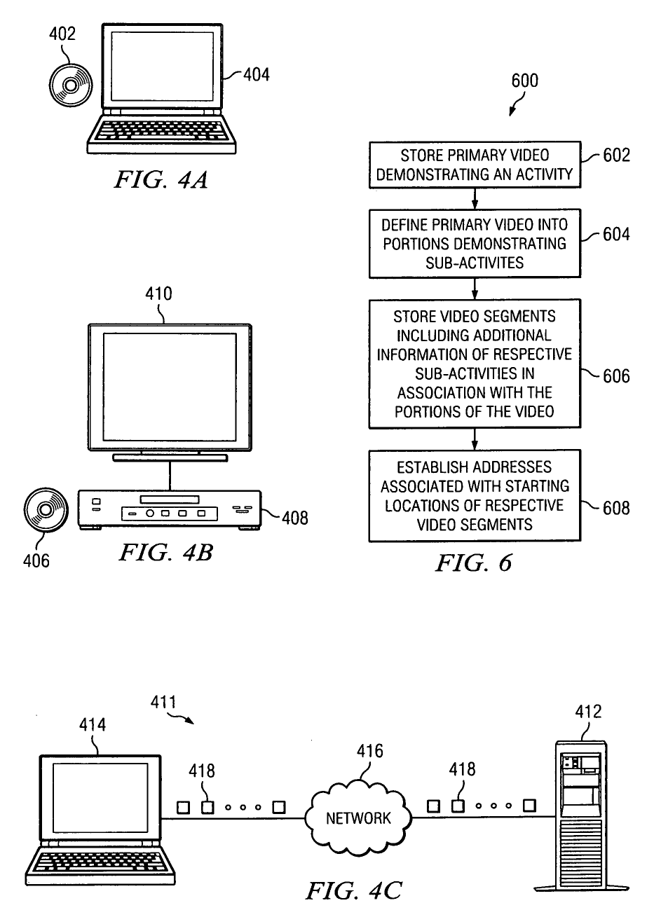

FIG. 4A-4C are illustrations of exemplary machine-readable media including video content that provides a user with the ability to view detailed information associated with a portion of a video in accordance with the principles of the present invention. FIG. 4A shows a computer-readable medium 402, which may be a compact disc (CD) or digital video disc (DVD), that may include video content stored thereon and readable by a computing device 404. The computer-readable medium 402 may be in any other form, such as a memory stick, hard drive, and the like. The video content may include video, text, graphics, or otherwise, as generally represented in FIGS. 1-3. The video content may be digital and include instructions that, when executed by a processor of computing device 404, cause the computing device 404 to display the video content and enable the viewer to view the video in the different view angles and view the video segments, including the additional information associated with the sub-activities displayed in the different portions of a demonstration video.

FIG. 4B shows an exemplary computer-readable medium 406, which may be a digital video disc (DVD) or other readable medium that can be read by a video player 408 capable of outputting video content stored on the computer readable medium 406 onto a computer monitor or television 410. The video player may be a DVD player, game console, digital video recorder (DVR), or otherwise. It should be understood that the principles of the present invention may be applied to any format of video disc, including Blu-ray Disc and HD DVD, for example.

FIG. 4C is an illustration of an exemplary embodiment of a system 411 that includes a server 412 configured to store video content as described hereinabove on a computer-readable medium, such as a hard drive. A user may access the video content being stored by the server 412, either located at or remotely from the server 412, using a computing device 414 or other electronic device, such as a set-top box or other network accessible device configured to access the server 412 via a network 416. In response to a user requesting video content from the server 412, the video content may be communicated via the network 416 in data packets 418 or other digital format and displayed on the computing device 414 or other electronic display, as understood in the art. It should be understood that the content communicated in the data packet 418 may include instructions that, when executed by a processor, cause the processor to display the video content and enable a user to interact with selectable indicia displayed on an electronic display using a pointing device, such as a computer mouse, or remote control device to control viewing video segments that include additional information associated with sub-activities being displayed in a video during a presentation, for example.

FIG. 5 is a block diagram of an exemplary configuration of a video and video segments associated with portions of the video. The configuration of the video content may include a primary video 502 that is defined in portions 504a-504n (collectively 504). Each video portion 504a-504n may include a sub-activity so that video segments 506 and 508, which are different views of the primary video, may be synchronized therewith. As shown, the primary video may be composed of N-portions, where each portion of the primary video 502 contains a different sub-activity and each of the different video segments 506 and 508 may have associated portions with different views. The primary video 502 may be a demonstration video that is continuous, as represented by dashed lines 510a and 510b, and the portions of the video may be defined in such a way that each portion abuts the adjacent portions of the primary video 502. Showing each of the portions separated in FIG. 5 is for illustration purposes.

Video segments 512a-512n (collectively 412) include additional or detailed information associated with sub-activities performed in each of the respective portions of the primary video 502. The video segments 512 may be any length of time to teach or provide additional information for performing a respective sub-activity. Links 514a-514n (collectively 514) may be established during an authoring process of a video stored on a computer-readable medium. The links 514 may represent addresses associated with the start of each of the video segments 512, respectively.

In operation, a menu 516 may be used to enable a viewer to selectively play the video 502 or a particular video segment 512a-512n. If the viewer decides to play the video, the process starts at step 516. The video begins to play at time 00:00, as shown in timeline 518 that shows start and stop markers for each portion of the primary video. At time 00:05, the primary video portion A 504a begins to play and is displayed on an electronic display. As the primary video portion A 504a is playing, one or more selectable indicia may be displayed on the screen in association with the video (see, for example, FIG. 1). During the display of the primary video portion A 504a, the user may select a selectable indicia to show a different view angle of the video currently being displayed. If a different view angle is selected, then the video switches to a respective video segment of a different view (e.g., from primary video portion B 504b to video segment B 506b), which, in one embodiment, plays a different view angle synchronously from where the primary video portion A was playing. In one embodiment, the entire video region 102 (FIG. 1) switches to show the different view angle, such as the video portion 202 of FIG. 2. Alternatively, the video segment showing a different view angle may be displayed simultaneously in a picture-in-picture video region (not shown), as understood in the art. If the viewer decides to switch back to watching the primary video 502, the viewer may select a selectable indicia (e.g., front soft-button 112n of FIG. 1) and return to the primary video at the same time sequence that was playing in the different view angle video segment. The viewer, of course, may use video control buttons on a remote control or keyboard to control fast forward, reverse, skip chapter, back chapter, etc. In the event of the viewer pressing a forward chapter button, the primary video 502 may skip between video portions, such as primary video portion A 504a to primary video portion B 504b.

While watching the primary video 502, a viewer may select a selectable indicia (e.g., help soft-button 110 of FIG. 1) to view a video segment associated with the sub-activity currently being displayed in the primary video portion. For example, if the viewer is watching primary video portion B 504b, in response to the viewer selecting the soft-button, the video switches to displaying video segment B 512b that includes additional information of the sub-activity. The entire video segment B 512b may be watched by the viewer and then, in one embodiment, automatically return to the primary video portion B 504b at the start of the video portion or at the instant when the viewer selected to switch to watch the video segment B 512b. Alternatively, the viewer may be required to select a selectable indicia (e.g., return soft-button 304 of FIG. 3).

To enable the viewer to be able to switch between the primary video 502 and video segments 506 and 508, such that the viewer sees the different views synchronously, a pointer or memory location may track the time at which the viewer was watching any of the respective videos at the time the viewer selects to watch a different video segment, thereby enabling an video player (e.g., DVD player) to play the video in whichever view angle is selected at the time stored in the pointer or memory location. If the viewer decides to learn additional information (e.g., learn how to perform a dance step or a certain step of a surgical procedure), another pointer or link address be associated with a video segment including the additional or detailed information stored therein. As the primary video 502 switches between portions (e.g., from portion A to portion B), the link address of an associated video segment (e.g., video segment A 512a) currently associated with a soft-button may be replaced with a new address of the beginning of the video segment (e.g., video segment B 512b) that includes the additional information associated with the sub-activity being displayed in the new primary video portion (e.g., primary video portion B 504b).

More particularly, if the viewer is watching the primary video between times 00:05 and 01:42, if the viewer selects a selectable indicia to see additional information associated with the sub-activity being displayed in the primary video portion A, then the video segment A 512a is displayed. When the primary video portion B 504b starts at time 01:42, the dynamic link that is storing the address of video segment A 512a will change to store an address of the beginning of video segment B 512b. If, during the time that the primary video portion B 504b is being displayed, the viewer selects the selectable indicia to display the video segment associated with the sub-activity being displayed, the video changes to play the video segment B 512b. Updating the address of the video segment associated with the portion of the primary video being displayed continues throughout the time that the primary video is being played. If, for example, there is no additional information associated with the sub-activity being played in a particular video portion of the primary video, then the selectable indicia may be “grayed out,” for example. When the primary video portion N 504n completes at time 49:20, the menu 516 may again be displayed.

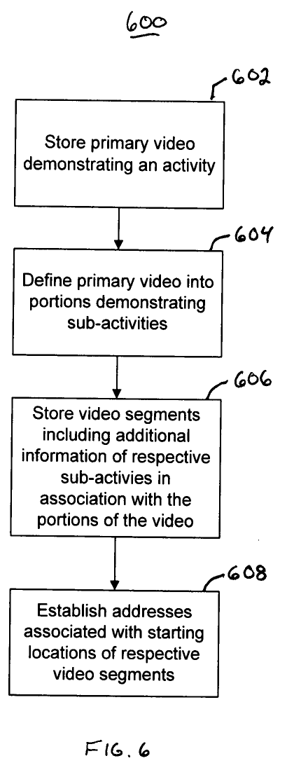

FIG. 6 is a flow diagram of an exemplary process 600 for enabling a viewer to view a video. The process 600 starts at step 602, where a primary video demonstrating an activity is stored. The primary video may be stored on any form of computer readable media, such as a DVD, CD, hard drive, or any other storage medium. At step 604, the primary video may be defined into portions demonstrating respective sub-activities of the activity of the primary video. For example, in the case of the primary video including a surgical procedure, each step of the surgical procedure may be defined as a sub-activity in respective portions of the primary video. At step 606, video segments associated with portions of the primary video may be stored. The video segments may include more detailed or additional information of respective sub-activities displayed in the respective portion of the primary video. At step 608, a set of addresses associated with starting locations of respective video segments may be established. The set of addresses may be stored in a list or may be established by creating links between the primary video and video segments during a video authoring process, as understood in the art. The addresses may be used in response to a user selecting a selectable indicia, where an address may be used to cause a video segment, including the additional information, to be displayed. By creating or authoring a video using the process 600, viewers of the video may be able to learn in a more intuitive manner by being able to select to learn additional information associated with a sub-activity without having to continuously rewind and re-watch a particular sub-activity being performed in the primary video or try and figure out which sub-activity was being performed in a list of sub-activities in a menu.

The previous detailed description is of a small number of embodiments for implementing the invention and is not intended to be limiting in scope. One of skill in this art will immediately envisage the methods and variations used to implement this invention in other areas than those described in detail. The following claims set forth a number of the embodiments of the invention disclosed with greater particularity.

What is claimed:

1. A video interface for teaching a user how to perform an activity, said video interface comprising:
a video region configured to display a primary video demonstrating an activity, the primary video defined by portions of primary video demonstrating respective sub-activities of the activity,
a plurality of video segments being associated with respective portions of the primary video, the video segments including additional information of respective sub-activities displayed in the respective portions of the primary video; and
a selectable indicia displayed in association with said video region, the selectable indicia using a link address to cause a video segment associated with a respective portion of the primary video being displayed at a time said selectable indicia is selected by a user to be displayed.

2. The video interface according to claim 1, wherein the activity includes dancing.

3. The video interface according to claim 2, wherein the sub-activities include particular dance steps.

4. The video interface according to claim 1, wherein said selectable indicia includes a soft-button.

5. The video interface according to claim 1, wherein the link address is an address of a starting point of a respective video segment.

6. The video interface according to claim 1, wherein the link address changes to point to a different video segment in response to the primary video switching from one video portion to another.

7. The video interface according to claim 1, further comprising a second selectable indicia displayed in association with said video region, the second selectable indicia providing a second link to cause a second video segment to be displayed, the second video segment associated with a respective portion of the primary video being displayed at a time said second selectable indicia is selected by the user to be displayed, the second video segment including a different angle from which the primary video was recorded.

8. The video interface according to claim 1, wherein said video segments include instructions for performing respective sub-activities.

9. The video interface according to claim 1, wherein the portions of videos are defined by a first marker and a second marker at which respective portions of the primary video starts and stops respectively.

10. A method for enabling a user to view a video, said method comprising:
storing a primary video demonstrating an activity;
defining the primary video into portions demonstrating respective sub-activities of the activity;
storing a plurality of video segments associated with respective portions of the primary video, the video segments including additional information of respective sub-activities displayed in the respective portions of the primary video; and
establishing a set of addresses associated with starting locations of respective video segments, in response to a user selecting a selectable indicia, an address within the set of addresses being used to cause the associated video segment to be displayed, the video segment being associated with a respective portion of the primary video being displayed at the time the user selects the selectable indicia.

11. The method according to claim 10, wherein storing the primary video includes storing a video including dancing.

12. The method according to claim 11, wherein storing the video includes storing subactivities including particular dance steps.

13. The method according to claim 10, further comprising creating a soft-button to be displayed, the soft-button being associated with a respective address of the set of addresses when a respective primary video portion is being displayed.

14. The method according to claim 10, further comprising establishing a second set of addresses associated with starting locations of respective second video segments, the second video segments including content of respective portions of the primary video, but at a different angle from which the primary video was recorded.

15. The method according to claim 10, wherein storing the video segments includes storing instructions for performing respective sub-activities.

16. The method according to claim 10, further comprising establishing a first marker and a second marker at which a respective portion of the primary video starts and stops.

17. A computer-readable medium on which computer instructions are stored, the computer instructions, when executed by a processor cause the processor to:
display a primary video demonstrating an activity, the primary video defined by portions of video demonstrating respective sub-activities; and
display a selectable indicia that, when selected by a user, causes a video segment to be displayed, the video segment including additional information of a respective sub-activity being in a respective portion of the primary video being displayed at a time the selectable indicia is selected by the user.

19. The computer-readable medium according to claim 18, wherein the processor is within a DVD player.

20. The computer-readable medium according to claim 18, wherein the computer-readable instructions further cause a second selectable indicia to be displayed that, when selected by the user, causes a second video segment to be displayed, the second video including the same content as a portion of the primary video, but filmed at a different angle than the primary video.

21. The computer-readable medium according to claim 18, wherein the computer-readable instructions, when executed by the processor, further cause the video segment to stop and the primary video to be displayed again.
